(19) United States
(12) Patent Application Publication
(10) Pub. No.: US 2006/0157543 A1
(43) Pub. Date: Jul. 20, 2006

(54) Fine grain titanium-alloy article and articles with clad porous titanium surfaces

(76) Inventors: Stanley Abkowitz, Lexington, MA (US); Susan M. Abkowitz, Burlington, MA (US); Harvey Fisher, Lexington, MA (US); Patricia J. Schwartz, Andover, MA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/269,764

(22) Filed: Nov. 9, 2005

Related U.S. Application Data
(60) Provisional application No. 60/626,493, filed on Nov. 10, 2004.

(51) Int. Cl. B23K 31/02

(52) U.S. Cl. 228/233.2

(57) ABSTRACT

Disclosed herein are alpha-beta titanium alloys processed above the beta transus temperature yet that maintain a fine grain structure. Disclosed herein are articles comprising a titanium alloy body and a porous titanium material attached to the body, wherein the titanium alloy body has a grain size of less than or equal to 0.1 inch. Such articles may be useful as orthopedic implant devices, such as those for the knee, hip, or other prostheses. Also disclosed is a powder metal process for producing such articles, which includes consolidating powdered metals to full density by pressing, sintering and hot isostatic pressing. The shape can be further extruded to a mill product or forged to near net shape.

This application claims the benefit of domestic priority to U.S. Provisional Patent Application Ser. No. 60/626,493, filed Nov. 10, 2004, which is herein incorporated by reference in its entirety.

Disclosed herein are alpha-beta titanium alloys processed above the beta transus temperature yet that maintain a fine grain structure. Also disclosed herein are such alloys that further comprise a porous titanium material on the surface, and articles comprising such alloys, such as welded articles, titanium rolled, extruded or forged products, in addition to implant devices with porous titanium surfaces. Also disclosed is a powder metal process for producing such articles.

Titanium alloys have been used in a variety of applications that require very high strength, including as prosthetic devices. There are two general methods of attaching prosthetic devices, such as used in the hip or knee, to bone. The first comprises cementing the prosthetic device in-place, and typically utilizes wrought titanium alloy components, such as Ti-6Al-4V, as the substrate material.

To improve biological fixation, a method of attaching implants to bone relies on bone ingrowth. To achieve the ingrowth of bone to the titanium prosthetic device, this method utilizes a porous coating on the wrought device body. This porous coating is typically comprised of titanium beads or titanium mesh pads that are applied by vacuum sintering to attach the beads or pads to the alloy body.

In order to achieve proper bonding, however, a vacuum sintering temperature well above the beta transus temperature of the alloy, is required. When heated to temperatures above the beta transus titanium alloys, such as the well-known alpha-beta alloys Ti-6Al-4V and Ti-6Al-7Nb, transform to a single phase beta structure that is prone to excessive grain growth, which is used herein interchangeably with “grain coarsening.” This grain growth has been shown to drastically reduce the ductility of the body of the device and results in lower fatigue resistance in the final product.

In contrast, if sintering is not performed at a high enough temperature the integrity of the bond is sacrificed. This can result in separation of the particles creating debris in the body.

There are two methods that are used to manufacture the titanium alloy body of the device. One method is to manufacture the body from wrought titanium that may be machined to the final body shape or, forged and then machined to the final shape. The second method is to cast the body to a near-net shape followed by machining the cast body to the finished shape.

Regardless of the manufacturing method used to produce the titanium alloy body the subsequent processing to apply the porous coating to the device body typically requires exposing the body to high temperature well above the beta transus. As previously mentioned, this subsequent step causes a grain coarsening which significantly lowers the ductility of the device and degrades fatigue resistance.

To overcome the adverse affects of grain coarsening in similar titanium alloy systems, the prior art teaches methods of reducing grain growth based on powder metallurgy. For example, U.S. Pat. No. 4,601,874 teaches forming a titanium base alloy with small grain size by powder metallurgy. The process described in this document is based on a dispersion of fine particles to curb the growth of the grain size. This dispersion is created by the addition of low solubility elements that precipitate during processing.

Further, the process discussed in U.S. Pat. No. 4,601,874 comprises the steps of compacting a powder formed of particles of titanium or titanium alloy powder, heat-treating the powder metallurgy (P/M) product at a temperature higher than the point of transformation into the beta phase and then quenching. While the object of this prior process is to create a fine-grained material, it does not teach or suggest the effect on grain growth when the alloy is reheated above the beta transus. Indeed, because this reference is not concerned with the application of porous coatings to the alloy (body), it does not teach the effects of grain growth associated with sinter bonding a porous titanium to the titanium alloy body.

To overcome the problems associated with the current method of producing fine grain articles having porous coatings thereon, the process disclosed herein utilizes a powder metallurgy technique. Unlike the prior art, however, the present invention does not depend on the incorporation of low solubility additional elements to create a dispersion and does not require heat treatment above the beta transus followed by quenching.

### SUMMARY

Disclosed herein, therefore, are alpha-beta titanium alloys processed above the beta transus temperature but that exhibit a grain size less than or equal to 0.15 inch, such as less than 0.1 inch. As described herein, such titanium alloys exhibit a significantly minimized grain growth during subsequent thermal processes, including sintering processes used to bond porous layers to the alloy. Also disclosed are articles comprising such alloys with a porous titanium material attached to the surface.

Also disclosed herein is a process for producing such articles. For example, in one embodiment, the powder composition is consolidated to full density by pressing (such as cold isostatic pressing), sintering and hot isostatic pressing to form the material to be used for the body of the device. The material thus produced can then be formed to near net shape. The material can also be used as stock for extrusion to a mill product which then is machined to shape. The material can also be used as stock which is then forged to near net shape. After machining to form the final shape of device body, high temperature sintering is employed to attach the porous coating.

The retention of a fine grain size after sintering to attach the porous titanium has made the resulting article particularly useful as a biological implant, including prosthetic devices used as knee and hip replacements.

### BRIEF DESCRIPTION OF THE DRAWINGS

FIG. 1 illustrates a knee implant device showing coarse grained Ti-6Al-4V resulting from sinter bonding a porous titanium surface.

FIG. 2 is a that illustrates the comparative grain size of a wrought titanium alloy bar and P/M titanium alloy bar after simulated sintering bonding at 2250° F. The wrought bar shows a coarse grain while the P/M manufactured bar has a much finer grain size.

FIG. 3 is a micrograph (10×) that illustrates the comparative grain size of a Ti-6Al-4V alloy after exposure to a sinter bond cycle for (a) a comparative wrought sample and (b) an inventive sample.

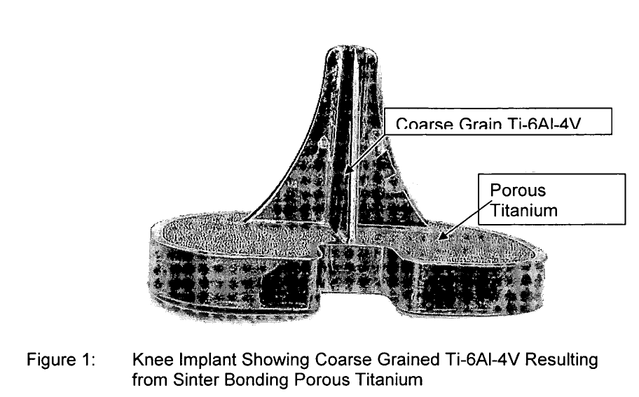

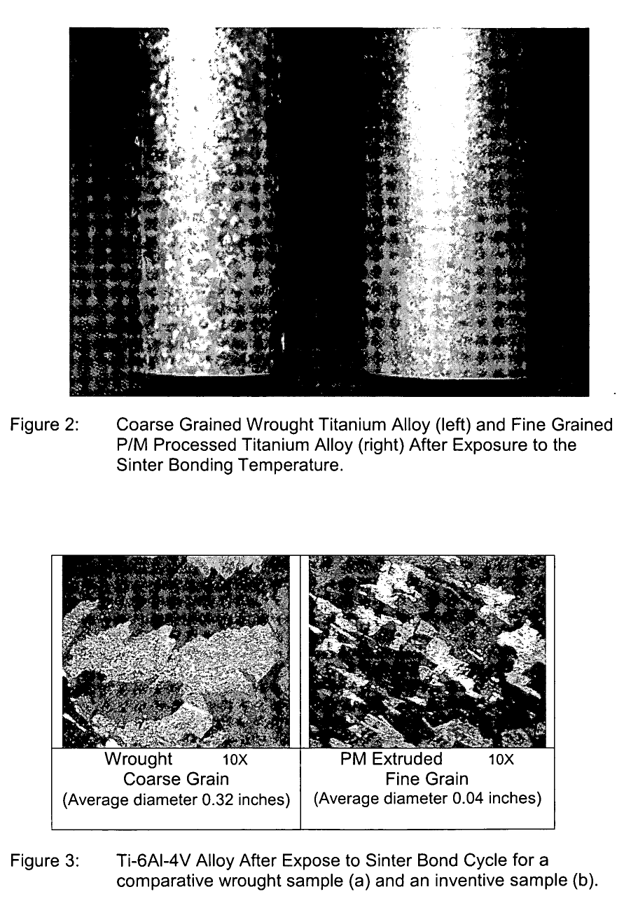

### DESCRIPTION OF THE EMBODIMENTS

In the broadest sense, the present disclosure is related to an article produced above the beta transus temperature, yet which maintains a fine grained structure, which is defined as less than 0.15 inch, less than 0.1 inch, such size ranging from 0.02 to 0.06 inch, or even 0.04 inch. Because of the unique method of processing this material; this fine grain size remains virtually unaffected by subsequent processing of the material. Therefore, there is disclosed an article comprised of a titanium alloy body with a porous titanium material attached to the surface, wherein the titanium alloy body of the device has significantly minimized grain growth during subsequent thermal processes used to bond the porous layer to the body.

The grain size discussed herein can be determined by a number distribution, e.g., by the number of grains having a particular size. The method is typically measured by microscopic techniques, such as by a calibrated optical microscope or a scanning electron microscope or other microscopic techniques. Methods of measuring particles of the sizes described herein are taught in Walter C. McCrone's et al., The Particle Atlas, (An encyclopedia of techniques for small particle identification), Vol. I, Principles and Techniques, Ed. Two (Ann Arbor Science Pub.), which is herein incorporated by reference.

In one embodiment, the titanium alloy body comprises alpha/beta alloys such as Ti-6Al-4V and Ti-6Al-7Nb, which can be used in the making of orthopedic or prosthetic devices. Because of the ability for bone ingrowth, such alloys having a porous layer are particularly useful in the making of prosthetic devices, such as those chosen from knee, hip, spine, and dental implants.

Also disclosed is a powder metallurgy process for producing a titanium article above the beta transus temperature comprising consolidating titanium alloy powder by cold isostatic pressing to form a compact and sintering the compact to form a sintered body at a temperature above the beta transus temperature. In one embodiment, the method of making the sintered product further comprises hot isostatic pressing the sintered body. Whether or not a hot isostatic pressing step is used, the finished article maintains a grain size less than 0.15 inch.

The powder metallurgy process described herein may further comprise treating the sintered titanium alloy with at least one additional process chosen from extrusion and forging after the sinter process or hot isostatic pressing, if used.

The above process can further include attaching a porous titanium material to the underlying Ti alloy. For example, such a process comprises first producing a body of the device by using powder metallurgy (P/M) techniques. In one embodiment, for example, a P/M composition is mixed by blending titanium powder and a master alloy powder, and a body is formed from a series of consolidation and heating processes to form a material, which can be extruded and machined to form a body. In another embodiment, the P/M material is forged to near net shape, and then machined to form a body. In either case, a porous layer is subsequently formed on the body by sintering loose titanium containing materials, such as beads, fibers, or mesh pads, to the body above the beta transus temperature.

In one embodiment, the process for manufacturing the body comprises adding a master alloy powder of specified chemistry and particle size range, such as 60% Al-40% V master alloy powder, to a titanium powder to create the composition for the body, such as a Ti-6Al-4V composition. A general method of making Ti-6Al-4V is described in U.S. Pat. No. 2,906,654, which is herein incorporated by reference. The blend is isostatically cold pressed followed by vacuum sintering. In one embodiment, the blend may be hot isostatically pressed after vacuum sintering.

In one non-limiting example, the blend may be first consolidated by cold isostatic pressing at 350 to 400 MPa, such as 379 MPa (55 ksi), followed by vacuum sintering at 1150 to 1250° C., such as 1200° C. (2250° F.) for a time sufficient to achieve a dense body. For example, vacuum sintering may be carried out for 120 to 180 minutes, such as for 150 minutes. Vacuum sintering is optionally followed by hot isostatic pressing at temperatures ranging from 850 to 950° C., such as at 899° C. (1650° F.) and for pressures ranging from 95 to 110 MPa, such as at a pressure of 103 MPa (15 ksi). Hot isostatic pressing is typically performed for a time ranging from 1 to 3 hours, such as 2 hours.

Depending on the end use, after the titanium alloy body is formed, a porous layer may be formed on the surface of the body by contacting a Ti material with at least one surface of the Ti alloy substrate. As used herein, “contacting” may include coating a Ti alloy surface with particulate Ti material and optionally pressing the Ti material onto the surface prior to or simultaneous with sintering. As mentioned, the particulate Ti material may comprise any substantially discrete particles of Ti, such as beads, fibers, and combinations thereof. Alternatively, mesh pads can be used as the basis for the porous Ti surface.

The time sufficient to integrally bond the porous titanium layer to at least part of the surface of the body typically ranges from 2 to 12 hours, such as from 7 to 8 hours, for example 7.5 hours.

In the powder metallurgy process described herein, the sintering treatment that bonds the porous titanium layer to the body does not result in a substantial increase in the grain size of the body. The sintering can for instance, comprise vacuum sintering at a temperature ranging from 2100° F. to 2400° F., such as at 2250° F.

The powder metallurgy process described herein may further comprise exposing the sintered P/M titanium alloy to at least one additional process chosen from extrusion and forging prior to attaching the porous titanium coating thereon.

It has been determined that material produced in this manner resists grain growth during the coating sintering treatment, for example, up to 2250° F. for 7.5 hrs, in contrast to the wrought product where excessive grain growth occurs.

As used herein, “fine grained” means particles having a mean particle size (such as a diameter or major axis) of less than 0.1 inch, such as a size ranging from 0.02 to 0.06 inch, and 0.04 inch. “Coarse grain” means particles above 0.15 inch, such as ranging from 0.15 to 0.55 inch, with 0.32 being one non-limiting example. “Medium grain” is a size between coarse and fine grained, e.g., such as ranging from 0.10 to 0.15 inch.

While not intending to be bound by any theory, it is believed that the 100% dense P/M produced Ti-6Al-4V still contains some residual porosity in the form of a dispersion of nanometer-sized voids (nanovoids) that pin the beta grains during sintering thus inhibiting grain growth.

Further, when this material is processed by the high temperature sinter bonding cycle test results show no loss in ductility of the body. This manufacturing process permits greater flexibility in design of devices that have been previously constrained by the competing concerns for particle loosening and loss of fatigue resistance.

The following non-limiting example compares embodiments of the present invention to a traditional wrought alloy.

### EXAMPLE

This example shows the effect of post-heat treatments on the grain size of Ti-6Al-4V samples made by the prior art (i.e., wrought Ti-6Al-4V, as shown in 1), as well as prepared using P/M techniques (shown in 2 and 3). The three samples are as follows:
1. Comparative—Wrought Ti-6Al-4V;
2. Inventive—Ti-6Al-4V prepared by the P/M process (P/M Ti-6Al-4V); and
3. Inventive—Ti-6Al-4V prepared by the P/M process and subsequently extruded (P/M Ti-6Al-4V extruded).

Comparative sample 1 was a commercially available wrought Ti-6Al-4V (ASTM-B-348 Grade 5) manufactured by President Titanium.

The P/M technique used to prepare samples 2 and 3 comprised adding a 60% Al-40% V master alloy powder to a titanium powder to obtain a Ti-6Al-4V composition. This blend was then consolidated by cold isostatic pressing at 379 MPa (55 ksi), followed by vacuum sintering at 1200° C. (2250° F.) for 150 minutes. The sample was then hot isostatic pressed at a temperature of 899° C. (1650° F.) and a pressure of 103 Pa (15 ksi) for 2 hours.

After the body was formed, each of the three samples were sintered at 2250° F. for 7½ hours, which represents a typical process for sinter bonding porous titanium to a Ti-6Al-4V alloy substrate. The results of this experiment are shown in Table 1.

TABLE 1
Table 1

| Sam- | | | Ultimate | | |
|---|---|---|---|---|---|
| ple | | | Tensile | Yield | % |
| Num- | | Grain | Strength | Strength | Elon- |
| ber | Description | size | (ksi) | (ksi) | gation |
| 1 | Wrought Ti—6Al—4V - | | 149.7 | 133.5 | 14.0% |
| | before sinter bonding | | | | |
| 1 | Wrought Ti—6Al—4V - | Coarse | 147.4 | 135.5 | 6.5% |
| | after sinter bonding | | | | |
| 2 | P/M Ti—6Al—4V - after | Medium | 142.9 | 125.2 | 8.3% |
| | sinter bonding | | | | |
| 3 | P/M Ti—6Al—4V | Fine | 134.8 | 116.9 | 13.4% |
| | extruded - after | | | | |
| | sinter bonding | | | | |

The results show that, as expected, the wrought Ti-6Al-4V has a coarse grain structure after sinter bonding while the P/M Ti-6Al-4V has a medium grain structure while the P/M Ti-6Al-4V extruded has a relatively fine grain structure. The difference in grain structure demonstrates the resistance to grain growth of the P/M Ti-6Al-4V during sinter bonding. The results also show that the ductility of wrought Ti-6Al-4V drops from 14.0% elongation before sinter bonding to 6.5% elongation after treatment while the P/M Ti-6Al-4V extruded showed better ductility then the wrought Ti-6Al-4V after the bonding treatment. P/M Ti-6Al-4V extruded had the highest ductility after treatment. It is anticipated that this improvement in ductility will reflect in an improvement in fatigue properties.

It is to be understood that both the foregoing general description and the following detailed description are exemplary and explanatory only and are not restrictive of the invention, as claimed.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An article comprising a titanium alloy substrate and a porous titanium material attached to the substrate, wherein said titanium alloy substrate has a grain size of less than or equal to 0.15 inch.

2. The article of claim 1, wherein said titanium alloy substrate comprises alpha/beta alloys chosen from Ti-6Al-4V and Ti-6Al-7Nb.

3. The article of claim 1, wherein said titanium alloy substrate has a grain size ranging from 0.02 to 0.06 inch.

4. The article of claim 1, wherein said article is a prosthetic device chosen from knee, hip, spine, and dental implants.

5. A powder metallurgy process for producing a titanium article above the beta transus temperature comprising:
consolidating titanium alloy powder by cold isostatic pressing to form a compact;
sintering said compact to form a sintered body at a temperature above the beta transus temperature, and
optionally hot isostatic pressing the sintered body,
wherein said titanium article has a grain size less than 0.15 inch.

6. The powder metallurgy process according to claim 5, wherein said hot isostatic pressing is performed at temperatures ranging from 850 to 950° C.

7. The powder metallurgy process according to claim 5, wherein said hot isostatic pressing is performed at pressures ranging from 95 to 110 MPa.

8. The powder metallurgy process according to claim 5, wherein said cold isostatic pressing is performed at a pressure ranging from 350 to 400 MPa.

9. The powder metallurgy process according to claim 7, wherein said sintering occurs in a vacuum at temperatures ranging from 1150 to 1250° C.

10. The powder metallurgy process according to claim 5, further comprising treating the sintered body with at least one additional process chosen from extrusion and forging.

11. The powder metallurgy process according to claim 5, further comprising forming a porous layer on the sintered body by bonding a Ti material to at least one surface of the sintered body, said bonding comprising contacting said Ti material with the sintered body and heating above the beta transus temperature for a time sufficient to bond the Ti material to the sintered body.

12. The powder metallurgy process according to claim 11, wherein said heating above the beta transus temperature comprises vacuum sintering at a temperature ranging from 2100° F. to 2400° F.

13. The powder metallurgy process according to claim 11, wherein said time sufficient to integrally bond the porous titanium layer to the surface of the substrate ranges from 2 to 12 hours.

14. The powder metallurgy process according to claim 11, wherein said Ti material comprises Ti beads, Ti fibers, Ti mesh, and combinations thereof.

15. The powder metallurgy process according to claim 11, wherein said porous titanium material attached to the substrate has a thickness ranging from 1 to 3 mm.

16. The powder metallurgy process according to claim 5, said process further comprising machining the sintered body to form a machined product.

17. The powder metallurgy process according to claim 5, wherein said titanium alloy substrate comprises alpha/beta alloys chosen from Ti-6Al-4V and Ti-6Al-7Nb.

18. A prosthetic device made by the powder metallurgy process according to claim 7, wherein said prosthetic device is chosen from knee, hip, spinal, and dental implants.

19. A prosthetic device comprising a titanium alloy substrate and a porous titanium material attached to the substrate, wherein said titanium alloy substrate has a grain size of less than or equal to 0.15 inch.

20. The prosthetic device of claim 19, wherein said titanium alloy substrate comprises alpha/beta alloys chosen from Ti-6Al-4V and Ti-6Al-7Nb.

21. The prosthetic device of claim 19, wherein said titanium alloy substrate has a grain size ranging from 0.02 to 0.06 inch.

22. The prosthetic device of claim 19, which is a chosen from knee, hip, spine, and dental implants.

23. A alpha-beta titanium alloy formed above the beta transus temperature, said alloy having a grain size less than or equal to 0.15 inch.

24. The alloy of claim 23, wherein said alpha/beta alloys are chosen from Ti-6Al-4V and Ti-6Al-7Nb.

25. The alloy of claim 23, wherein said grain size ranges from 0.02 to 0.06 inch.

26. An article comprising the alloy of claim 23, said article being chosen from welded, rolled, extruded, and forged titanium products.

27. The article of claim 26, further comprising a porous titanium surface attached thereto.

28. The article of claim 27, wherein said article is a prosthetic device chosen from knee, hip, spine, and dental implants.
